(19) United States
(12) Patent Application Publication
(10) Pub. No.: US 2004/0043361 A1
(43) Pub. Date: Mar. 4, 2004

(54) Decorative acrylic-based images on vinyl magnetic substrates for attachment to metal and metal-like substrates and method for making same

(76) Inventor: Pamela A. Bialas, Portage, PA (US)

Correspondence Address: LATHROP & GAGE LC, 4845 PEARL EAST CIRCLE, SUITE 300, BOULDER, CO, 80301, US

(21) Appl. No.: 10/234,590

(22) Filed: Sep. 4, 2002

(51) Int. Cl. G09B 11/00

(52) U.S. Cl. 434/81

(57) ABSTRACT

The present invention provides magnetic articles of acrylic paint and/or acrylic pigment on vinyl magnetic sheeting for home and office decor use. These articles are of a high quality image and are customized to the selection of the user. They feature the advantage of being securely mountable to a metal-like substrate without creating a mar or other blemish to the substrate on which they are attached. They may be prepared using magnetic sheeting and acrylic or acrylic-based paints and acrylic pigments. The invention further provides pattern packets for creating the articles. The pattern packets include a line drawing of a desired image in a one-piece construction pattern and an instruction sheet that includes a step-by-step procedure for creating the image, as well as a listing of the items that will be needed to create the image desired. The items needed to create the image desired are specific acrylic paint and/or acrylic pigment and a piece of magnetic sheeting. The invention further provides a kit that comprises the materials needed to create the image identified in the line drawing, such as specific acrylic paint and/or acrylic pigment, and the magnetic sheeting. The invention also provides an instructional visual and/or audio presentation in a machine-readable medium, such as a videocassette, audiocassette, or DVD, of the step-by-step process by which the decorative article is made.

### FIELD OF THE INVENTION

The invention relates to the field of decorative and functional articles that are detachably adherent to a non-wooden substrate, such as the metal or metal-like substrate of a door or cabinet. The invention also relates to the field of painted surfaces, as the articles described herein provide high definition images using acrylic paints and pigments that adhere well to a vinyl or vinyl-covered surface. The invention further relates to a process for creating a decorative article of virtually any image desired with acrylic paint and pigments on vinyl or vinyl-covered sheeting, the decorative article being magnetic and capable of being attached to a metal or metal-like substrate, while also presenting a high quality and vibrant decorative appearance suitable for functional home decor use.

### BACKGROUND OF THE ART

It is frequently desired to temporarily decorate an area or substrate, such as the outside of a door, or to change the decor of an area periodically with the season or special occasion/event, such as a birthday. Message boards and the like may have visual design features that blend or contrast with other decorative accessories within the home. By way of example, a holiday wreath or other item of home decor may be placed on a door using a wall hanger, or nail that would be placed into the surface to support the article. This creates a permanent mar on the substrate to which the wreath or other item was to be affixed. With the advent of metal doors and doors made of materials that are of a non-wooden finish, a need exists in the art for alternative ways that an article of door or wall decor may be selectively attached to a metal or metal-like substrate.

Several approaches have been proposed for affixing an item of home decor to a non-wooden substrate. For example, suction cups that employ a vacuum to hold an article onto a smooth surface have been described in U.S. Pat. No. 2,277,981 to Horton. This patent relates to a flag mounted to a channeled extension that is integral with a suction cup. This solution suffers from the problem that the vacuum in the suction cup is generally not well maintained, resulting in eventual release of the suction cup from the surface. In addition, this approach provides an attachment that is not particularly strong and does not bear any significant amount of weight or shear-force. In certain climates, the suction cup looses adherence after a short amount of time, and the item slides away and falls from the surface, resulting in the decorative article being damaged and/or soiled. U.S. Pat. No. 2,069,942 to Cohen is an example of an improved suction cup, having an annular groove that improves maintenance of the vacuum. U.S. Pat. No. 3,148,856 to Orlando is an example of an improved suction cup structure in which a magnet is included for interacting with a smooth magnetizable surface, thus assisting the maintenance of the suction cup vacuum. While suction cup-based mounting devices can be located anywhere on a flat, smooth surface, they suffer from the need to include a rather large base structure that includes the suction cup and the integral mounting devise for the article to be attached thereto. Consequently, suction cup mounting devices are not well suited to the task of mounting decorative articles.

Anther type of mounting solution involves the use of magnetic materials. U.S. Pat. No. 3,082,982 to Moskowitz relates to a staff support having a staff holding base, to which is attached, in one plane, three projections, each having an end including a permanent magnet. U.S. Pat. No. 3,131,897 to Skelter et al. discloses a base made of a rubberized sheet having magnetized particles therein, to which is attached a plurality of upstanding spines for holding a floral display. U.S. Pat. No. 4,058,335 to Abe relates to a magnetic mounting devise, which utilizes a magnetic sheet having a shape that causes a suction action when the magnetic sheet is attracted to a magnetizable surface. U.S. Pat. No. 4,87,676 to Weinhaus relates to an elastomeric material interposed in a magnetized surface and a magnet for improved frictional resistance to lateral forces.

Magnets have also commonly been used to hold papers and the like against a substrate material, such as to the surface of a kitchen appliance (e.g., refrigerator). However, where simple metal magnets have been used, they often abrade or discolor the surfaces on which they have been used. The use of separate magnets also creates a distracting appearance in relation to the materials being displayed.

One alternative to the magnet is the use of magnetic strip materials to affix an item to a substrate. The strips are made of flexible polymer having dispersed therein a plurality of small magnetic iron particles. The strips may be mounted, e.g., to contain an advertisement for a business or product. Prior art articles that are die-cut and/or molded from a filled elastomer frequently did not present the high quality visual image desired for the creation of decorative wall and door decor. Moreover, these particular types of prior art items were inherently incapable of receiving and securing non-magnetic display materials there over, being able to only hold display material in place beneath them. In addition, because the magnetic material itself was an elastomer rather than a thermoplastic material, bonding thermoplastic materials to the magnetic material by heat sealing or the like was not possible.

Thus, a need continues to exist in the area of decor fabrication for a high quality and detail-rendering article that is adapted for convenient attachment to modern, non-wooden interior and exterior substrates.

### SUMMARY OF THE INVENTION

According to the present invention, the problem of providing attractive and functional decorative articles that non-destructively attach to non-wooden substrates and doors has been overcome. The particular articles of the present invention provide the solution, and further possess numerous advantages and characteristics not heretofore available.

The articles of the present invention address the problem that existed in the art for items that attach to a metal door without the need for creating a nail hole or other blemish to the metal or metal-like substrate. Metal and metal-like substrates are found in most modern homes and businesses, are not amenable to the use of conventional nails and wall-hanging brackets without damaging the substrates. The articles of the present invention may also address the problem associated with the quality of the image that had previously been available with other detachable magnetic items, as the manner in which the acrylic paint image is created on the vinyl sheeting is such that both the color, definition and detail of the image prepared with an acrylic paint and acrylic pigment is preserved.

According to various embodiments of the invention, a customized and high quality acrylic paint and acrylic pigment image of a single piece construction on a vinyl or vinyl-covered magnetic sheeting may be provided. By way of example, the vinyl material to which the image may be affixed is a magnetic vinyl sheeting material. Once the acrylic paint image is affixed to the vinyl magnetic sheeting, for example using a specific combination of acrylic or acrylic-based paints and pigments, the decorative item may be affixed in a detachable manner to any desired metal or metal-like substrate, such as a door to a room, appliance door (refrigerator, dish washer, toaster, oven, cabinet door, file cabinet, screen door, metal frame, window frame, etc.), or other desired surface.

The acrylic paint image that is to be created as part of the decorative items herein disclosed may take any variety of decorative motifs. By way of example, these motifs include: an animal (rabbit, rooster, cat, dog, cow, turkey, horse, buffalo, llama, bird, spider, monkey, reindeer, ferret, skunk, stork, forest animal (bear, fish, squirrel), etc.), hearts, flowers (pansies, wild-flowers, roses daisies, bluebonnet, violet, drop flower, periwinkle, lily, antherium, morningglory, bird-of-paradise, ginger, etc.), birthday cake, candles, balloons, clowns, leaves, insects (butterflies, lady-bug, grasshopper, ant, dragonfly, fly, bee, wasp, etc.), fruit (apples, cherry, banana, strawberries), vegetables (carrots, onions, mushrooms, asparagus, broccoli, squash, pumpkin, etc.), stars, planets, bird houses, water bucket, clouds, books, chairs, cars, diamonds, stars, plants (trees, ferns), wreaths, garlands, Jack-O-Lanterns, Santa Claus, patriotic motif (flag, Uncle Sam face, rockets, red/white/blue heart, streamers, banners, confetti, etc.), landscapes (mountains, sunset, ocean, beach scene), cowboys, snowmen, babies, angels, and the like.

The present invention may provide a decorative article that possesses a flexible magnetic backing, the decorative article being adapted to receive a high quality image in vibrant and colorful detail in virtually any desired and/or customized configuration. The image may be coated for protection against abrasion to normal use with, for example, a sealant material included over the painted image after it has dried completely.

As used in the description of the present invention, the type of substrate on which the decorative articles may be affixed is further described as metal or metal-like in composition on at least some part of its exterior surface. A metal-like substrate may be further described as comprising iron, steel, tin, loadstone, an alloy thereof, a composite thereof, any combination thereof, or other material that has the property of providing a magnetically attractive substrate to which the magnetic vinyl sheeting of the decorative article provided in the present invention may securely adhere. The exterior metal or metal-like substrate provides at least enough surface area so as to be able to accommodate at least a significant portion of the decorative vinyl magnetic article being placed thereon.

In one embodiment, an article for home or office decor in the form of a magnetic attachment to a metal or metal-like substrate is provided, comprising an elastomeric magnetic material capable of accepting thereon a one-piece image made in a specified acrylic or acrylic-based paint or pigment design on at least one side thereof. This article of home or office decor may be further described as being capable of magnetically attaching in a non-destructive manner to a metal or metal-like substrate, such as, of a door or wall surface.

By way of example, the decorative article may also have functional uses, such as a door wreath, a refrigerator magnet, a memo/message board, a memo board, a chalk board, a leave-a-note board, a cabinet hook, a wall hanging, a sun-catcher, a planter ornament, a window decoration, etc.

The selected decorative pattern or motif of the article of decor may be, for example, a one-piece constructed image of a flower and garden watering pail design. This design may be even further defined as comprising a plurality of flowers, such as hydrageous, in a garden-watering pail. In another embodiment, the selected decorative pattern of the article is a welcome hen, or a welcome hen atop a bail of hay design. In yet another embodiment, the design selected may be a rooster, a garden watering pail, a holiday Christmas door wreath, a birthday cake design, a butterfly design, an Uncle Sam face, a Santa face, an “Americana” star, pansies in a pot, a patriotic heart, roses in a window box, or perhaps a combination of all or any of these designs. For example, a combination of these designs may function to create a desired collage of these decorative items for a desired interior or exterior metal or metal-like surface. The designs may be, for example, implemented in a printing process lined upon a tole printing stylus.

These embodiments may be used as a door magnet, such as an ornamental magnetized item for the door of a refrigerator.

In another embodiment, the invention provides a pattern-pack. In some embodiments, the pattern-pack is designed for use in hand-painting a magnetized decorative article. In particular, the pattern pack will comprise a line pattern of a selected design, an instructional sheet of step-by-step procedures of creating the article of home decor on a magnetic vinyl sheet material, such as detail instruction for positioning of the colors within the line pattern; and a materials list of items for creating the selected design, including a list of specific acrylic paint and pigment colors for the selected one-piece design of the pattern-pack.

In particular aspects, the pattern-pack may be for a magnetic door ornament. In another aspect, the pattern-pack may be for a design of flowers, such as hydrangeas or pansies, in a garden-watering pail. The particular decorative article of the pattern-pack may, for example, provide an exterior door ornament, or for the door of a kitchen appliance, such as a refrigerator. The pattern-pack may further include a plurality of line drawings such as the ones described here.

The present invention also provides a kit. The kit will include selected acrylic paints, a piece of vinyl sheeting, selected vinyl pigments, paint brushes, a line drawing of a selected decorative article, a color picture of the selected decorative article, tracing paper and a step-by-step instruction sheet. The kit may also include a book of a variety of the selected decorative designs that may be made using the acrylic paints and magnetic vinyl sheeting. The kit in yet additional embodiments may further include an instructional visual program on a machine-readable format material demonstrating said step-by-step procedure for creating the article of home or office decor.

In some embodiments of the kit, the magnetic vinyl sheeting will be of a size of about 7 inches to about 10 inches wide, and about 12 inches to about 15 inches long. The sheeting in other embodiments will have a dimension of about 7¼inches in width and about 13 inches in length. It is envisioned that the magnetic sheeting of the kit will have a minimal dimension of about 5 inches in width and about 6 inches in length in order to provide a readily visible article of decor. Articles of less than 5 inches in width, such as about 3½ inches in width, and of a length of less than 6 inches in length, would not be particularly well suited for creating the articles of decor intended for the present invention.

In yet another aspect, the invention provides an instructional visual program on a machine-readable material, such as in videotape, DVD, or Internet transmitted visual presentation, that presents a step-by-step visual program useful in instruction on how to create the decorative magnetic articles of home decor described herein.

The invention in yet another aspect will provide an Internet system that may be used to order articles of the acrylic and acrylic-based paint and acrylic pigment decorative items. The Internet system will also provide digital images of the decorative designs, and may be updated to include additional images as they become available to potential purchasers of the items.

### BRIEF DESCRIPTION OF THE DRAWINGS

FIG. 1—“Americana” Star Door Magnetic Door Ornament

FIG. 2—“Hydrangeus in a Garden Water Pail” Magnetic Door Ornament

FIG. 3—“Birthday Cake” Magnetic Door Ornament

FIG. 4—“Welcome Baby” Announcement Magnetic Door Ornament

FIG. 5—“Santa” Holiday Decor

FIG. 6—“Uncle Sam” Face Magnetic Door Hanging Decorative Article

FIG. 7—“Pansies in a Pot” Magnetic Door Ornament

FIG. 8—“Angel” Magnetic Door Ornament

FIG. 9—“Patriotic Heart” Magnetic Door Ornament

FIG. 10—“Roses in a Window Box” Magnetic Door Ornament

### DETAILED DESCRIPTION OF THE PREFERRED EMBODIMENTS

As used in the description of the present invention, the term “metal substrate” is intended to include any surface that has a magnetic affinity for magnetized sheeting. Such surfaces include, but are not limited to, a metal, tin, hematite or other magnetic rock, or a second magnetized surface, such as a magnet itself. Other surfaces such as aluminum or copper may be painted or coated with a material that is impregnated with magnetic particles to provide a magnetized substrate.

As used in the description of the present invention, an article of home or office decor is to be understood to relate to items of decorative art, such as a front door wreath, and not incidental pieces of magnetic ornaments that are used for other than decorative applications. Other types of articles not particularly included are articles that are not sufficiently visible to provide as an art item. One of the distinguishing characteristics of the present invention relates to the size of the items. In order to function as a decorative article of home and office decor, the articles of the present invention are of a size of at least 7 inches in width and 12 inches in length. Thus, the items of the invention are significantly larger than typical refrigerator magnets. Typical refrigerator magnets have dimensions of about (1) inch to about three (3) inches in width and about 1 (one) inch to about six (6) inches in length. An article of this size would not be particularly suitable for a front door, as it would not be readily visible from an outside vantage point, and thus not serve the purpose of providing a decorative article suitable on an exterior or interior room door, for example.

At times, it may be desirable to delete details in the first transfer of a selected decorative pattern to a piece of tracing paper. This is particularly the case where there are areas in the selected decorative design that require a basecoat of paint before a color is applied. In this case, the details of the decorative design should be traced onto the article of magnetic sheeting after the basecoat has dried.

The vinyl sheeting that is included in the creation of the decorative articles of the invention may be obtained form any variety of sources. One source that these materials may be obtained readily from is: Transfer Technology, Web site: www.transfertechnology.com. The acrylic and acrylic-based paints and pigments that may be used for the creation of the decorative article also may be obtained from any variety of vendors of such products. One source for these acrylic paints is Folkart Paints, where the Folkart® Acrylic Colors and the Folkart® Artists' Pigment Colors can be purchased.

The brushes that may be used for the invention include Loew-Cornell® brushes. (Flat shaders, Series 7399 0 sizes #4, #6, #8, #10, #12; Liner, Series 7350—sizes #1 and 10/0; Deerfoot, Series 7850—size ¼″, Deerfoot Series 410—size ½″; Wash Brushes, Series 7550 sizes 2″ and ¼″). In addition, a foam brush for applying the finish will be needed. The finish used on the article is Folkart® Outdoor Sealer, gloss finish 861. This type of finish offers a durable, long lasting finish over the magnetic surface, especially since the article of decor as used on an exterior door, for example, may be exposed to inclement weather.

Additional materials that may be needed in creating the decorative articles of the present invention are a palette, tracing paper for tracing the line designs (such as a Christmas Wreath), transfer paper and stylus for transferring patterns, scissors for cutting the magnetic sheeting, sponge for creating mottled backgrounds, Folkart® Floating medium 868 for shading, masking tape for masking off boarders, and paper towels for removing excess paint and for clean-up.

While the preferred embodiments of the invention are described below, it will be recognized and understood that various modifications may be made in the invention and that the appended claims are intended to cover all such modifications that may fall within the spirit and scope of the invention.

### EXAMPLE 1

### “Santa” Holiday Decor Door Wreath

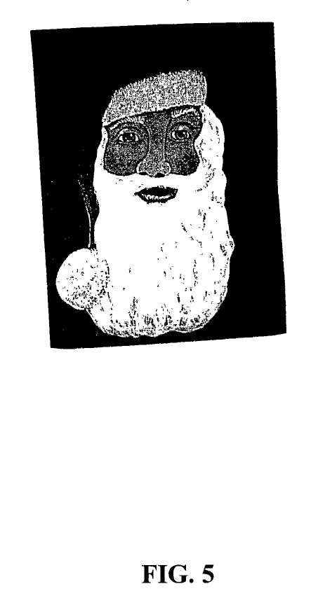

The present example describes an embodiment of the invention as a door magnet. In particular, it describes an embodiment of the invention as an article of home decor for a door, particularly a metal door, for use as a wreath. The wreath in this example is a holiday wreath, such as a Christmas wreath in FIG. 5.

As an initial step, a piece of vinyl magnetic sheeting was selected. The sheeting was cut with scissors to form a manageable piece, and sized to approximate dimensions exceeding those of the decorative item. The sheeting is measured and marked with the desired size with easily readable marks, such as with a pencil or chalk of contrasting color. The marked piece was then cut out of the sheeting roll, for example, using a straight edge, scissors, or a craft knife.

The pattern sheet, or line drawing, was first transferred by tracing the design onto a piece of tracing paper with a pencil or pen. To transfer the pattern onto a piece of tracing paper, the article design was placed on a work surface, and then the tracing paper is laid on top of the pattern. The pattern is viewable though the tracing paper, and the design is traced onto the tracing paper with a stylus.

For the finish, the image prepared upon the vinyl sheeting was dried, and then the image was sealed with two or three coats of outdoor sealer, using a foam brush to apply it.

### EXAMPLE 2

### Pattern Pack for a Magnetic Door Hanging Decorative Article

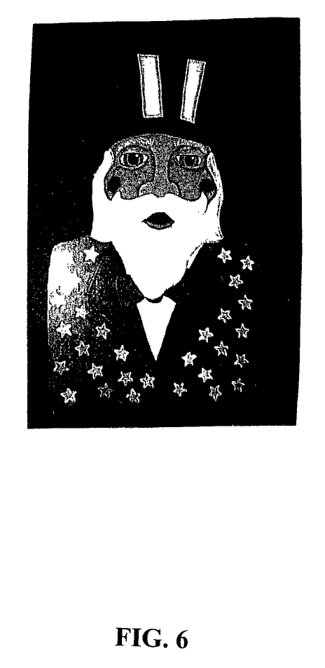

The present example presents a pack of materials that will be used in conjunction with the presently described decorative articles of the invention. The pack will include a line drawing of, for example, an Uncle Sam face as depicted in FIG. 6. In addition, the pattern pack will include a set of directions that detail the method by which the design noted in FIG. 6 is to be prepared. The pack will also identify the particular colors and shades of the acrylic paint colors identified for creation of the design of FIG. 6. In addition, the pack will specify the magnetic sheeting material needed for preparation of the design.

The image prepared upon the vinyl sheeting was dried, and then the image was sealed with two or three coats of outdoor sealer, using a foam brush to apply it.

### EXAMPLE 3

### Pattern Pack “Hydrandgeus and Garden Watering Pail” Wall Magnet

The present example presents a pack of materials that will be used in conjunction with the presently described decorative articles of the invention, termed a “pattern-pack”, that will also include at least some of the materials that will be used in creating the article herein described.

The pattern-pack would include a line drawing of this decorative article, a step-by-step instruction sheet of the steps to creating this article, and a list of the materials needed to create the article. This materials list will include a list of the specific Acrylic colors and Artists' pigment colors needed for this item.

For the finish, one would wait until the image prepared upon the vinyl sheeting is dry. At that time, the image will be sealed with two or three coats of outdoor sealer, using a foam brush to apply it.

### EXAMPLE 4

### Memo Board

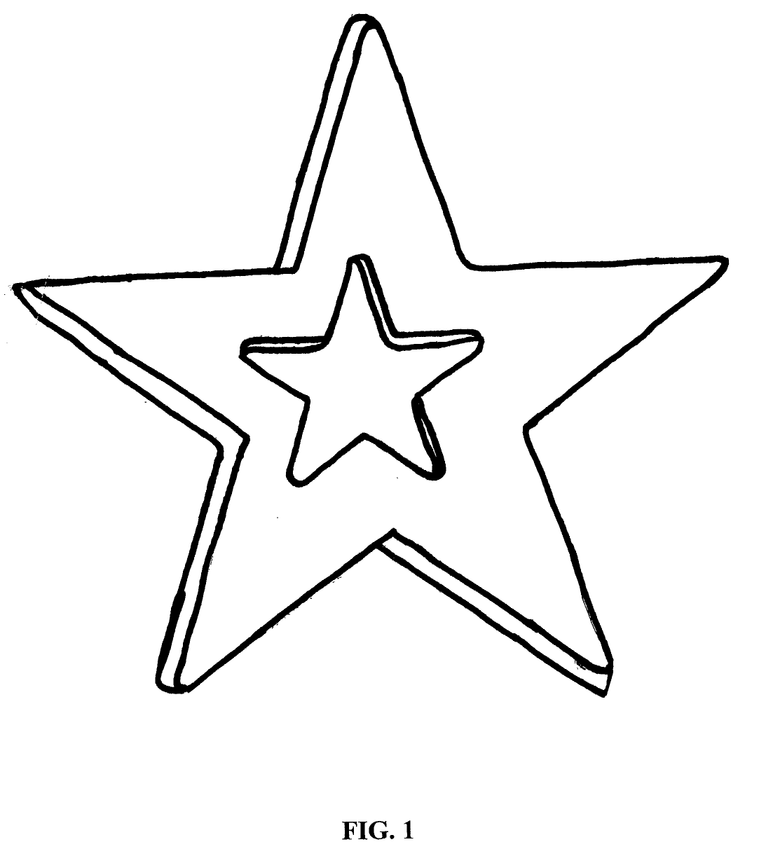

The present example presents a pack of materials that will be used in conjunction with the presently described decorative articles of the invention, termed a “pattern-pack” for creation of the Memo Board. The article will have a design, for example, of a border of “Americana Stars” as depicted in FIG. 1 around a memo board suitable for writing upon with chalk.

The pattern-pack will include a line drawing of this decorative article, a step-by-step instruction sheet of the steps for creating this article, and a list of the materials needed to create the article. This materials list will include a list of the specific Acrylic colors and Artists pigment colors needed for this item.

For the finish, no sealing is needed. The surface may be written upon directly with chalk, as the surface has been finished with chalkboard paint. A piece of Velcro® will be attached to the board and around a piece of chalk as an additional feature.

### EXAMPLE 5

### Instructional Visual and/or Audio Program

The present example describes an instructional visual and/or audio program in a machine-readable format that will provide a step-by-step presentation of how to make the various acrylic and acrylic-based paint and pigment decorative articles of the present invention. These are expected to take the form of, for example, videotapes, audiotapes, DVD, etc. The program of instruction is also expected to be available though an Internet access using a personal computer.

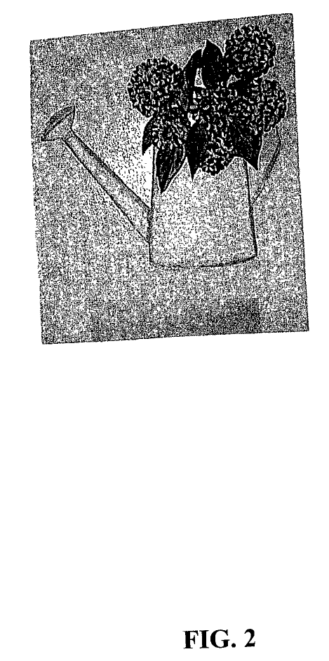

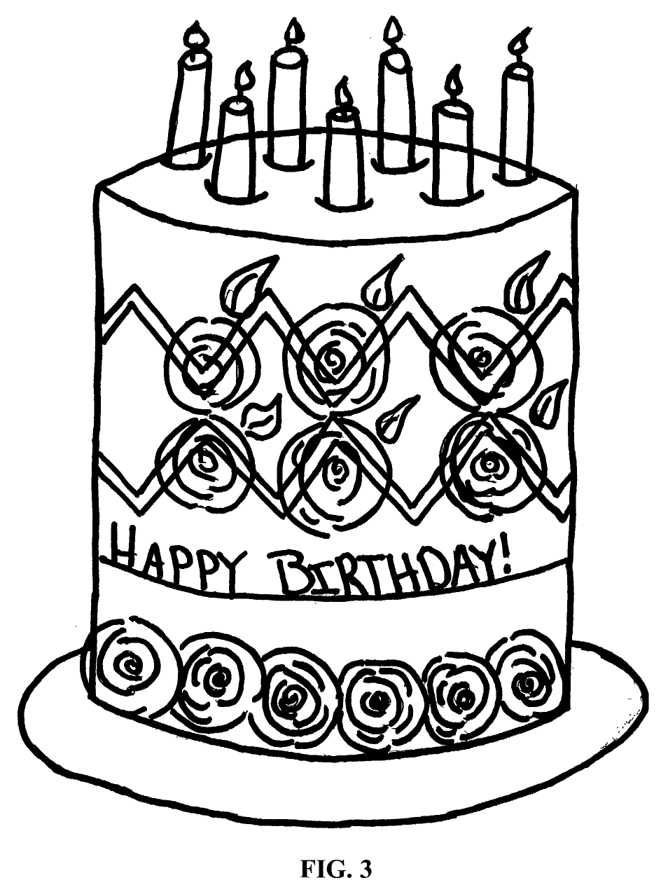

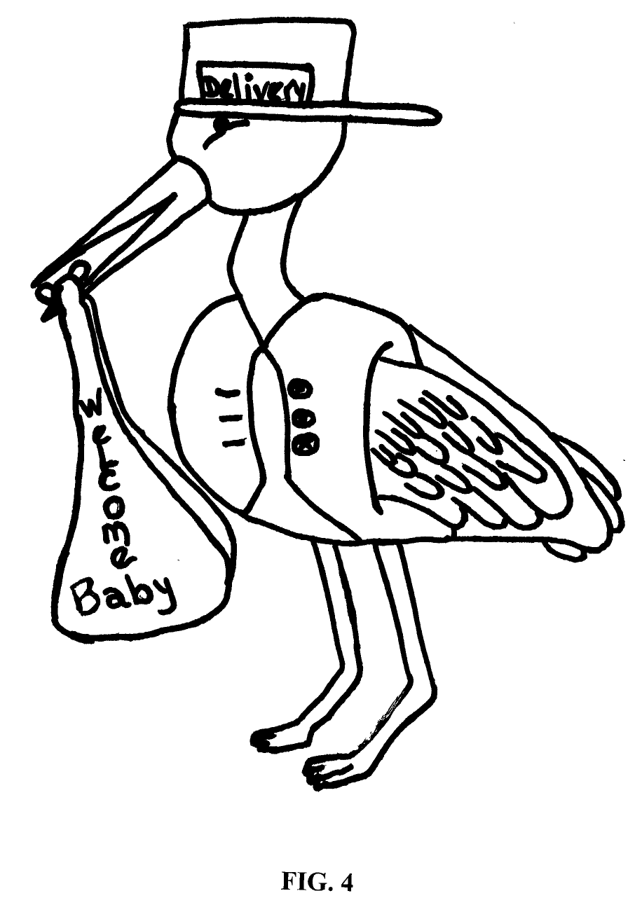

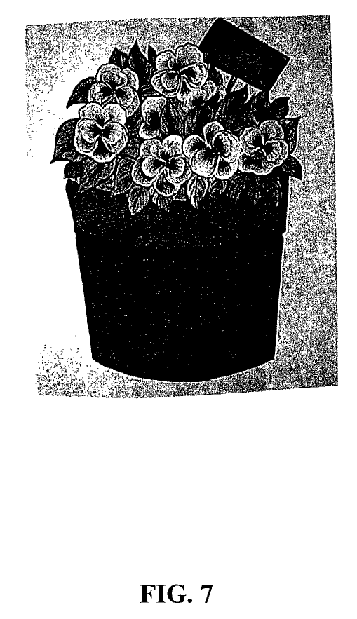

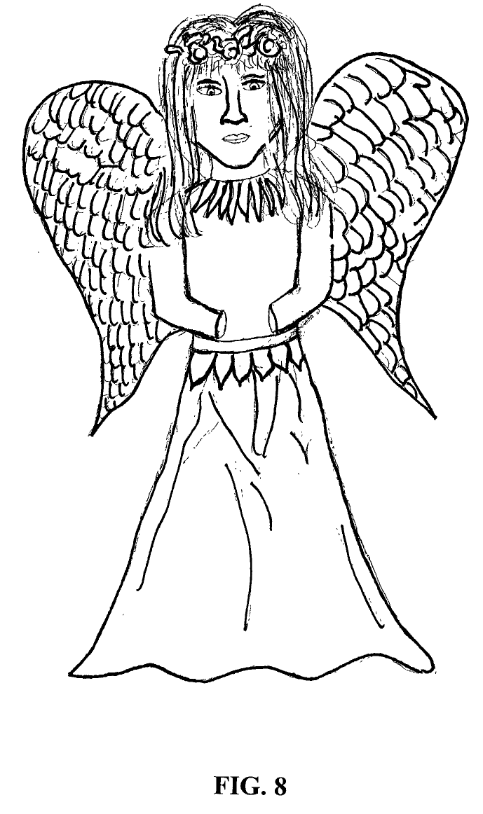

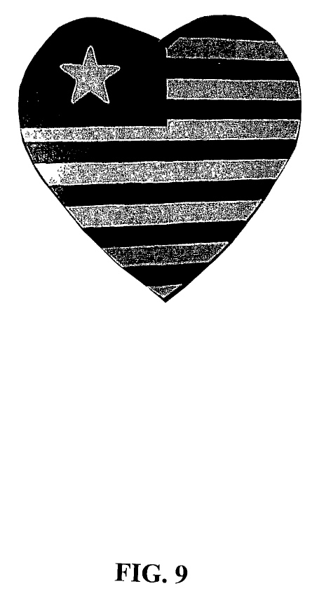

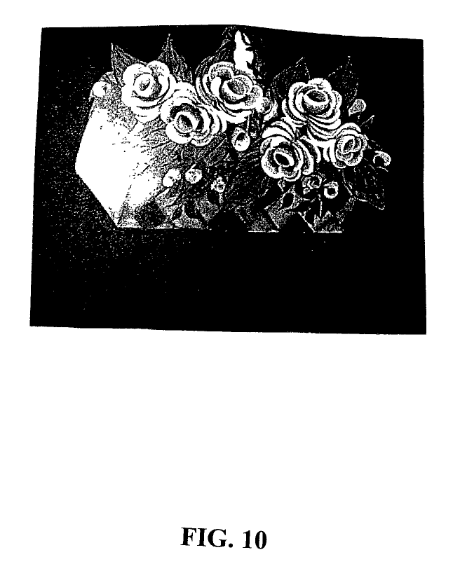

The instructional program will demonstrate the steps used in the preparation of each of the items identified in the FIGS. 1-10, as well as demonstrate basic techniques used in preparing and working with the acrylic paints and acrylic pigments to create a decorative, one-piece, article of home/office decor.

### EXAMPLE 6

### Kit for Magnetic Decorative Art

The present example describes a kit that includes the decorative magnetic articles of the present invention.

The kit will comprise at least one line drawing of a selected decorative article, an instruction sheet with step-by-step description of the creation of the selected decorative article, a color picture of the finished selected decorative article, a piece of tracing paper; a piece of magnetic vinyl sheeting, and selected acrylic paints and acrylic pigments that correspond to identified colors and pigments of the selected decorative article. The kit may optionally include a book of the various decorative articles that may be created on a magnetic vinyl sheeting using acrylic or acrylic-based paints and pigments.

What is claimed is:

1. A decorative article of a one-piece construction for home or office for magnetic attachment to a metal or metal-like substrate comprising:
a vinyl magnetic material capable of accepting thereon an acrylic or acrylic-based paint or acrylic pigment; and
a selected decorative pattern of a one-piece construction, provided in an acrylic or acrylic-based paint or acrylic pigment on one side of said vinyl magnetic material,
wherein said decorative article is capable of adhering in a detachable and non-destructive manner to the metal or metal-like substrate.

2. The decorative article of claim 1 further defined as a magnetized article for use on an appliance surface.

3. The decorative article of claim 2 wherein the appliance surface is a refrigerator door.

4. A pattern-pack for a magnatized decorative article, said pattern-pack comprising:
a line drawing of a selected one-piece construction decorative design;
an instruction sheet that includes a step-by-step procedure for creating the decorative article on a vinyl magnetic substrate; and
a materials list of items for creating the decorative article, said items comprising acrylic paint colors and acrylic pigment colors specific for said decorative article.

5. The pattern-pack of claim 4 comprising a plurality of line drawings.

6. The pattern-pack of claim 4 wherein the selected decorative artilce is a size of about 7 inches in width and about 12 inches in length.

7. A kit for creation of a magnetic decorative article in acrylic paint and/or acrylic pigment on a vinyl magnetic substrate, said kit comprising:
a line drawing of a selected one-piece construction decorative design;
an instruction sheet that includes a step-by-step procedure for creating the decorative article of one-piece construction on a vinyl substrate;
a materials list of items for creating the magnetic decorative article comprising selected acrylic paint colors and acrylic pigment colors for the selected decorative design of the line drawing; and
a piece of magnetic sheeting material.

8. The kit of claim 7 further comprising an instructional visual program on a machine-readable format material demonstrating said step-by-step procedure for creating the decorative article.

9. The kit of claim 8 wherein the instructional visual program is further defined as on a machine-readable format of a videotape or a DVD.

10. The kit of claim 7 further comprising a piece of tracing paper.

11. The kit of claim 7 further comprising the selected acrylic paint colors and acrylic pigment colors.

12. A machine-readable instructional video or audio-tape of a step-by-step procedure for creating the decorative article of claim 1.
